(19) United States
(12) Patent Application Publication
(10) Pub. No.: US 2023/0367551 A1
(43) Pub. Date: Nov. 16, 2023

(54) IN-MEMORY COMPUTING METHOD AND APPARATUS

(71) Applicant: Samsung Electronics Co., Ltd., Suwon-si (KR)

(72) Inventor: Dong-jin CHANG, Suwon-si (KR)

(73) Assignee: Samsung Electronics Co., Ltd., Suwon-si (KR)

(21) Appl. No.: 17/971,764

(22) Filed: Oct. 24, 2022

(30) Foreign Application Priority Data
May 16, 2022 (KR) 10-2022-0059534

(51) Int. Cl. G06F 7/544; G06F 1/06

(52) U.S. Cl. CPC G06F 7/5443; G06F 1/06

(57) ABSTRACT

An in-memory method and apparatus are included. An in-memory computing (IMC) macro includes an IMC array that includes an IMC configured to share sub-clock signals that are generated based on an external clock signal and control respective columns having a crossbar structure, the IMC is further configured to perform a matrix product operation between weight bits by units of columns thereof and input bits of an input vector, the weight bits being sequentially loaded, according to the sub-clock signals, from a memory cell array comprising memory cell units, and an enabling circuit configured to generate enabling signals for enabling the weight bits included in each of the plurality of columns, for each of the plurality of memory cells.

### CROSS-REFERENCE TO RELATED APPLICATIONS

This application claims the benefit under 35 USC § 119(a) of Korean Patent Application No. 10-2022-0059534, filed on May 16, 2022, in the Korean Intellectual Property Office, the entire disclosure of which is incorporated herein by reference for all purposes.

### BACKGROUND

### 1. Field

The following embodiments relate to an in-memory computing (IMC) method and apparatus.

### 2. Description of Related Art

Neural networks (NN) in various forms are trained by machine learning and/or deep learning and may be used in various application fields. Algorithms that enable the learning and inferencing of neural networks may invoke large amounts of machine operations, although such algorithms may be performed by processing basic operations such as a multiplication and accumulation (MAC) operation of multiplying two vectors and adding values thereof.

However, in a computer with a traditional Von Neumann structure, the performance of a system memory and/or a cache memory may not match the performance of a processor, and accordingly, rapidly performing large amounts of MAC operations may be impeded due to a bottleneck that may occur while the memory and the processor exchange data to be used in such MAC operations, for example.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an in-memory computing (IMC) unit includes a memory cell configured to store a weight vector as columns of weight bits, the memory cell unit further configured to apply an input vector to the weight vector, the input vector including rows of input bits, wherein the IMC unit is configured to apply the rows sequentially, as units of rows, to the columns, a timing generator configured to, based on an external clock signal, generate sub-clock signals for selecting the columns as units of columns, a multiplying and accumulator (MAC) logic circuit configured to perform a single-bit matrix product operation between the weight bits and the input bits, the weight bits being sequentially loaded to the MAC logic circuit from the memory cell unit according to the sub-clock signals, and a first accumulation operator configured to output multi-bit matrix product operation results respectively corresponding to the input bits by shifting and adding operation results of the MAC logic circuit according to the sub-clock signals.

The timing generator may be configured to sequentially generate the sub-clock signals, at least some of which have different phases with respect to each other, for selecting the columns, based on an external clock signal that may be generated outside of the IMC unit.

The timing generator may be configured to generate the sub-clock signals such that at least some of the sub-clock signals have different phases with respect to each other or such that at least some pairs of the sub-clock signals may be in an ON state at the same time.

The MAC logic circuit may be implemented by a dynamic logic circuit that may include a domino logic and/or by a static logic circuit, and wherein the dynamic logic circuit may be configured to operate as a pipeline in accordance with the sub-clock signals to perform the single-bit matrix product operation.

The MAC logic circuit may include AND gates respectively corresponding to elements of the input vector, wherein the number of AND gates may be greater than or equal to the number of elements, and one shared adder may be configured to perform an addition operation on outputs of the AND gates.

The MAC logic circuit may be configured to perform the single-bit matrix product operation by performing multiplication operations between each of the weight bits and each of the input bits by using the AND gates and performing an addition operation on results of the multiplication operations by using the one shared adder.

The first accumulation operator may be implemented as a dynamic logic circuit that may be configured to operate according to the sub-clock signals, and the dynamic logic circuit may have a register form and may include at least one of a dynamic flip-flop or a true single phase clock (TSPC).

A second accumulation operator may be configured to shift the multi-bit matrix product operation results by one bit and add the multi-bit matrix product operation results according to the sub-clock signals to output a multi-bit matrix product operation result corresponding to the input vector.

A row enabling block may be configured to generate row enabling signals for enabling the weight bits by respective units of rows.

The row enabling block may include AND gates respectively corresponding to elements of the input vector, and one OR gate configured to perform an OR operation on outputs of the respective AND gates.

The row enabling block may be configured to enable the weight bits by units of rows by performing an AND operation between each of the input bits and the row enabling signals using the AND gates.

AND gates may be configured to perform an AND operation between an output signal of the OR gate and each of the sub-clock signals such that a load of weight bits is prevented within the IMC unit in a case where the corresponding input bits are not input to the memory cell, wherein the number of AND gates corresponds to a number of dimensions of the weight vector.

In one general aspect, an in-memory computing (IMC) macro includes an IMC array that includes an IMC configured to share sub-clock signals that are generated based on an external clock signal and control respective columns having a crossbar structure, the IMC is further configured to perform a matrix product operation between weight bits by units of columns thereof and input bits of an input vector, the weight bits being sequentially loaded, according to the sub-clock signals, from a memory cell array comprising memory cell units, and an enabling circuit configured to generate enabling signals for enabling the weight bits included in each of the plurality of columns, for each of the plurality of memory cells.

The IMC may include the memory cell array, within which the memory cells may be arranged in units of rows, a timing generator may be configured to generate the sub-clock signals based on the external clock signal, a multiplying and accumulator (MAC) logic array may be configured to perform a matrix product operation between the weight bits and the input bits through pipelining, the weight bits being sequentially loaded to each of the memory cells according to the sub-clock signals, and a first accumulation operator may be configured to output multi-bit matrix product operation results corresponding to the input bits by shifting and adding operation results of the MAC logic array according to the sub-clock signals.

The timing generator may be configured to generate overlapping clock signals obtained by overlapping sub-clock signals having different phases for each of the respective columns, and the MAC logic array may be pipelined by the overlapping clock signals to perform a single-bit matrix product operation.

The timing generator may be driven according to a control signal for controlling generation of the sub-clock signals for each of the columns.

The MAC logic array may include MAC logic circuits respectively corresponding to the memory cells, and each of the MAC logic circuits may include AND gates respectively corresponding to elements of the input vector, and one shared adder may be configured to perform an addition operation on outputs of the AND gates.

The enabling circuit may include a row enabling block corresponding to each of memory cells, and wherein the row enabling block may include AND gates respectively corresponding to elements of the input vector, and one OR gate configured to perform an OR operation on outputs of the AND gates.

In one general aspect, a method of operating a memory includes a memory cell unit, the method includes storing a weight vector as weight bits in units of columns, the weight vector being applied to an input vector may further include input bits sequentially input in units of rows, generating sub-clock signals for selecting the weight bits in the units of columns, based on an external clock signal, sequentially loading the weight bits, column by column, from the memory cell unit according to the sub-clock signals, performing a single-bit matrix product operation between the weight bits and the input bits, shifting results of the single-bit matrix product operation by one bit and adding the single-bit matrix product operation results according to the sub-clock signals to output multi-bit matrix product operation results respectively corresponding to the input bits, and shifting the multi-bit matrix product operation results by one bit and adding the multi-bit matrix product operation results according to the sub-clock signals to output a multi-bit matrix product operation result corresponding to the input vector.

A multiply-and-accumulate (MAC) operation between the input vector and the weight vector, the MAC operation may further include the single-bit matrix product operation and the multi-bit matrix product operation.

Other features and aspects will be apparent from the following detailed description, the drawings, and the claims.

### BRIEF DESCRIPTION OF THE DRAWINGS

FIG. 1 illustrates a structure of an in-memory computing (IMC) unit, according to one or more embodiments.

FIG. 2 illustrates an external timing diagram of the IMC unit according to one or more embodiments.

FIG. 3 illustrates an internal timing diagram of the IMC unit, according to one or more embodiments.

FIG. 4 illustrates a process in which a matrix product operation is performed according to sub-clock signals in the IMC unit, according to one or more embodiments.

FIG. 5 illustrates a structure of an IMC unit, according to one or more example embodiments.

FIG. 6 illustrates clock signals generated by a timing generator, according to one or more embodiments.

FIG. 7 illustrates a schematic form of a crossbar structure of the IMC unit, according to one or more embodiments.

FIG. 8 illustrates a structure of an IMC macro, according to one or more embodiments.

FIG. 9 illustrates a method of implementing various types of vector products by using multiplying and accumulator (MAC) logic in the IMC macro, according to one or more embodiments.

FIG. 10 illustrates an example in which the IMC macro is used for a matrix product operation of a convolutional neural network, according to one or more embodiments.

FIG. 11 illustrates an operating method of the IMC unit, according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. When describing the examples with reference to the accompanying drawings, like reference numerals refer to like or similar components and a repeated description related thereto is omitted.

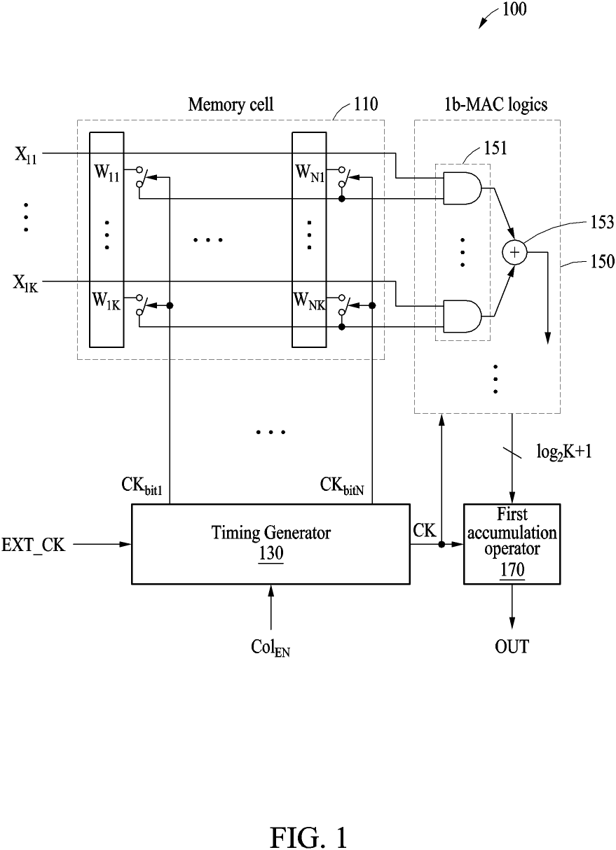

FIG. 1 illustrates a structure of an in-memory computing (IMC) unit, according to one or more embodiments. Referring to FIG. 1, an IMC unit 100 includes a memory cell unit 110, a timing generator 130, a multiplying and accumulator (MAC) logic circuit 150, and a first accumulation operator 170. The IMC unit may also be referred to as a “computing in-memory unit (CIMU)” or a “near memory computing unit (NMCU)”, reflecting the notion that computation may be performed directly through the memory cell unit data subject to the computation remains in the memory cell unit. For example, the memory cell unit may include any type of memory cell for storing bits, e.g., static random access memory (SRAM), dynamic random access memory (SRAM), or the like.

The memory cell unit 110 stores a weight vector W of weight bits. The memory cell unit 110 may store the weight bits in bit cells of the memory cell unit 110, respectively. The weight bits may be organized (and operated on) in units of columns. The rows of the memory cell unit 110 may store bits of words (e.g., weight values in the form of binary numbers). A J-th column may store the J-th bits of weight values/words. That is, each column stores bits that correspond to a given power of 2 for the words/rows that intersect the row. The columns may be columns of 1-bit values and the rows may be rows of 1-bit values. As will be described, the weight vector W may be applied to an input vector X. The input vector X may be made up of input bits stored, for example, outside of the memory cell unit 110 (e.g., in a cache buffer, another memory cell unit, etc.). The input bits may be arranged in units of rows (relative to the columns of the memory cell 110) aligned with the rows of the memory cell unit 110. That is, each element/value of the input vector X may be a binary number arranged as a row of input bits (the rows may be rows of 1-bit values). The rows of input bits may be sequentially input, in units of rows, to the memory cell 110. That is, each of the J-th bits of the respective input rows may be fed to the memory cell unit 110 at the same time, then the (J+1)-th bits, etc.

As noted, the input bits may be sequentially input to the memory cell unit 110 according to a bit position of each of elements included in the input vector X. For example, the first bits of each input row, then the second bits of each input row, etc. The input vector X may be, for example, previously transmitted to an input buffer through an on-chip network (OCN), but is not necessarily limited thereto.

The input vector X may include K elements (vector values), for example, X₁₁, X₁₂, ..., X_{1K}. As described below, the first value “1” may be an index of the input vector among many input vectors, but for discussion, only one input vector X is mostly described; the second value (1...K) is an index of the elements of X. Each of the K elements may respectively include N input bits. That is, each input row (element) may be N bits. In addition, the number of elements of the input vector X (i.e., K) may correspond to the number of word lines of the memory cell unit 110 (there may be additional unused word lines in some implementations, depending on the size of the input vector). In an example described next, the input vector X has K=3 elements which are N=4 bits each. Specifically, the input vector X may include, for example, three elements, such as X₁₁[1011], X₁₂[0100], and X₁₃[0110], and each of the elements may include four input bits.

For the weight vector W, for example, first weight bits, such as W₁₁, W₁₂, W₁₃, ...W₁ₖ, (to be respectively applied to first bits of the elements of the input vector X) may be configured as a bit cell array that is (or is part of) a first column (from the left) in the memory cell unit 110. Similarly, second weight bits, such as W₂₁, W₂₂, W₂₃, ...W₂ₖ, (to be respectively applied to second bits of the elements of the input vector X) may be configured as a bit cell array that is (or is part of) a second column (from the left) in the memory cell unit 110. Also, third weight bits, such as W₃₁, W₃₂, W₃₃, ...W₃ₖ, (to be respectively applied to third bits of the elements of the input vector X) may be configured as a bit cell array that is (or is part of) a third column (from the left) in the memory cell unit 110. Fourth weight bits, such as W₄₁, W₄₂, W₄₃, ...W₄ₖ, (to be respectively applied to fourth bits of the elements of the input vector X) may be configured as a bit cell array that is (or is part of) a fourth column (from the left) in the memory cell unit 110.

The memory cell unit 110 may be configured with a bit-parallel/bit-serial (BPBS) scheme in which the input bits of the input vector are sequentially input in units of rows (i.e., the first bits of each row, then the second bits of each row, etc.) and the weight bits respectively corresponding to the input bits are stored in units of columns. The BPBS scheme may be thought of as a hybrid of bit-parallel and bit-serial architectures, in that input rows are inputted to the memory cell unit 110 one bit at a time (serially), however, bits from multiple rows may be inputted in parallel to the memory cell unit 110.

The input signal applied to each word line in the memory cell unit 110 may be mapped to the input vector, and data (e.g., a weight bit) stored in each bit cell inside the memory cell unit 110 may be mapped to the weight vector. A logical value generated (outputted) on each bit line through the mapping described above may be transferred to the MAC logic circuit 150, which performs a digital MAC operation on the selected/generated bits. Herein, the word line may correspond to, for example, a line in a row direction (or a parallel structure) in the memory cell unit 110, and the bit line may correspond to, for example, a line in a column direction (or a serial structure) in the memory cell unit 110.

The timing generator 130 may generate an asynchronous clock signal CK_{EN} according to an external clock signal EXT_CK. Herein, it may be understood that the “asynchronous” clock signal is expressed as asynchronous, since the asynchronous clock signal is not strictly synchronized with an external clock signal EXT_CK. To elaborate, “asynchronous” refers to the timing of pulses of the asynchronous clock signal CK_{EN} with respect to each other; initiation of a sequence of pulses of the clock signal CK_{EN} may depend on the external clock signal EXT_CK. In some embodiments, the external clock signal EXT_CK may be a signal that drives memory functionality, e.g., writing/reading data to/from the memory cell unit 110, refreshing the data, etc., but may not directly drive the in-memory computing.

The timing generator 130 may sequentially generate sub-clock signals CK_{bitJ} (J from 1 to N), which are pulses for selecting respective lines in the column direction of the memory cell unit 110, based on the asynchronous clock signal CK_{EN}.

The timing generator 130 generates the sub-clock signals CK_{bit1} to CK_{bitN} for selecting weight bits by the units of columns (one whole column at a time is selected, i.e., CK_{bitJ} selects the J-th weight column), based on the external clock signal EXT_CK. The timing generator 130 may sequentially generate sub-clock signals having different phases for sequentially selecting the weight bits by units of columns (i.e., for selecting columns of weight bits), based on the external clock signal EXT_CK.. The phrase “weight bits by the units of columns” refers to a bit cell array corresponding to one bit line in the column direction in the memory cell unit 110.

For example, the sub-clock signal CK_{bit1} may switch, to an ON state, the weight bits of the first column (“first” referring to first from the left in the memory cell unit 110), i.e., a first bit cell array may be switched to an ON state by the CK_{bit1} signal. Also, for example, the sub-clock signal CK_{bitN} may switch to an ON state the weight bits of a last column in the memory cell unit 110, i.e., an N-th bit cell array may be switched to an ON state.

As the bit cell arrays (bit columns) of the memory cell unit 110 are sequentially switched to an ON state by the sub-clock signals CK_{bit1} to CK_{bitN} (and bits thereof are transferred to the MAC logic circuit 150), the corresponding input bits may also be sequentially transferred to the MAC logic circuit 150. For example, when the first sub-clock signal CK_{bit1} is ON, the first bits of each input row may be transferred to the MAC logic circuit 150 and the weight bits of the first weight column may be transferred to the MAC logic circuit 150.

The sub-clock signals CK_{bit1} to CK_{bitN} generated by the timing generator 130 may be transferred/provided to the MAC logic circuit 150 and the first accumulation operator 170. In addition, the timing generator 130 may generate overlapping clock signals (described below) obtained by overlapping sub-clock signals having different phases.

The timing generator 130 may be driven by a control signal Col_{EN} (Column Enable) for enabling driving of the corresponding memory cell unit 110. Herein, the control signal may correspond to, for example, a column control signal Col_{EN}, as described below.

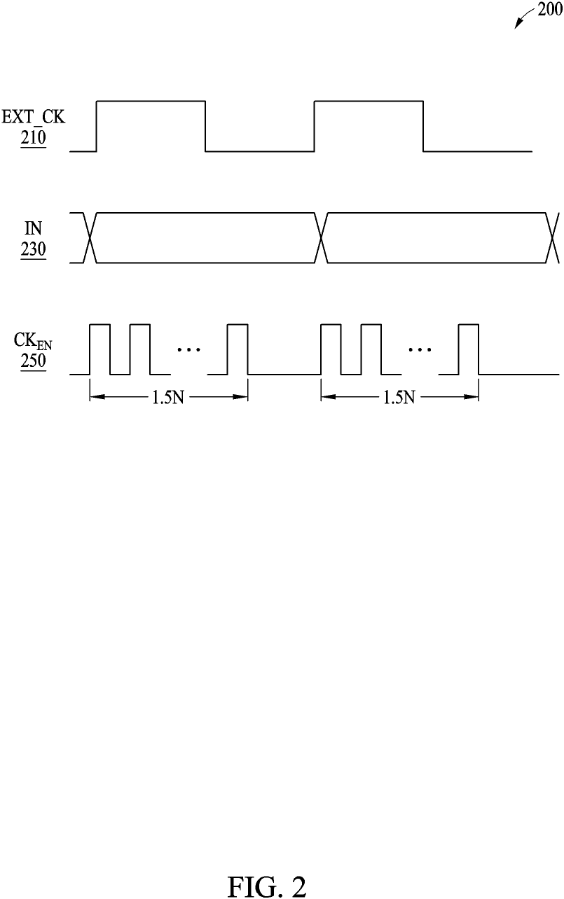

The sub-clock signals generated by the timing generator 130 are described in more detail with reference to FIGS. 2, 3, and 6 below.

The MAC logic circuit 150 may perform a single-bit matrix product operation between weight bits and input bits, the weight bits being sequentially loaded (transferred) from the memory cell unit 110 (column by column) to the MAC logic circuit 150 according to the sub-clock signals CK_{bit1} to CK_{bitN} generated by the timing generator 130.

The MAC logic circuit 150 may include AND gates 151 respectively corresponding to the number (e.g., K) of elements of the input vector (there may be more, depending on the size of the input vector), and one shared adder 153 configured to perform an addition operation on outputs of the respective AND gates 151.

The AND gates 151 of the MAC logic circuit 150 may perform multiplication operations between each of the weight bits and each of the input bits (e.g., a given AND gate multiples/ands two bits of corresponding weight and input elements at corresponding positions). The MAC logic circuit 150 may perform a single-bit matrix product operation by performing an addition operation on results of the multiplication operations of each of the AND gates 151 by using the one shared adder 153 (although single-bit products (multiplications/adds) are computed with AND gates (next paragraph), the term “matrix product” reflects the notion that bits of multiple elements are being computed (multiplied and added) at once). The MAC logic circuit 150 may transfer, for example, a single-bit matrix product operation result (the result having a size of log₂K + 1 bits) to the first accumulation operator 170. Herein, K may correspond to the number of elements of the input vector and the number of word lines of the memory cell unit 110.

In some embodiments, the memory cell unit 110 is configured using the BPBS scheme for characteristics of a memory in which an area (density) is important, however, the bit cells of the memory cell unit 110 may share the one shared adder 153 included in the MAC logic circuit 150, which performs a 1-bit MAC operation according to time (i.e., for same weight and input elements, different bits are operated on at different times). The MAC logic circuit 150 may reduce the number of adders for the MAC operation by using the one shared adder 153, thereby significantly reducing a delay of the MAC logic circuit 150, while reducing the area of the MAC logic circuit 150 and/or the IMC unit 100.

The MAC logic circuit 150 may be implemented by, for example, at least one or any combination of a dynamic logic circuit including a domino logic or a static logic circuit. Herein, it may be understood that the “static logic circuit” is a logic circuit included in a library provided from a foundry when a digital circuit is implemented. The “dynamic logic” circuit may be distinguished from a so-called static logic circuit in that the dynamic logic circuit utilizes a temporary storage of information by strays and gate capacitances. Generally, the dynamic logic circuit may operate faster and have a smaller surface area than the static logic circuit (thus allowing the clock signals of the MAC logic circuit 150 to outpace the external clock). The dynamic logic circuit has a higher toggle speed than that of the static logic circuit, but has a smaller toggled capacitive loads, and thus, the total power consumption of the dynamic logic circuit may be higher or lower than the power consumption of the static logic circuit in accordance with various tradeoffs. In addition, the dynamic logic circuit can be distinguished from the static logic circuit in that, for example, the dynamic logic circuit uses a clock signal to implement a combinational logic circuit.

The dynamic logic circuit may operate, for example, in a setup phase or a pre-charge phase performed when the clock is low and an evaluation phase performed when the clock is high. In the setup phase, the output may be constantly driven as “high” regardless of an input value and a capacitor may be charged by a load capacitance. In the evaluation phase, in a case where the input value is high, the output becomes low, and in a case where the input value is low, the output can be maintained in a high state due to the load capacitance.

In other words, the dynamic logic circuit may correspond to a logic circuit which performs a logic operation with an operation of, using a logic switch, discharging and/or charging a value that is pre-charged and/or pre-discharged with respect to a parasitic capacitor by using a clock signal. Since the dynamic logic circuit has a function of holding/retaining the value after the evaluation phase by gate capacitances or the like, a pipeline action can be performed through the overlapping clock signals, e.g., where two “adjacent” (consecutive) sub-clock signals are active at the same time.

The MAC logic circuit 150 implemented as a dynamic logic circuit may be pipelined by, for example, sub-clock signals or an overlapping clock signal CK_{OVL}, to perform a single-bit matrix product operation. Herein, “pipelining” refers to dividing a plurality of instructions, which are basic units of operation processing, by each stage and sequentially proceeding with each stage to increase processing performance as if the plurality of instructions is executed at the same time. The plurality of instructions may include instructions such as, for example, fetch, decode, operation execution, store, and the like, but is not limited thereto.

The first accumulation operator 170 may output multi-bit matrix product operation results respectively corresponding to input bits corresponding to each word line by shifting and adding operation results of the MAC logic circuit 150 according to the sub-clock signals CK_{bit1} to CK_{bitN} or the overlapping clock signal CK_{OVL}, either generated by the timing generator 130. Note that shift is an operation that defines the output of MAC and the number of digits of the stored accumulated value. Therefore, both the MAC output and the stored accumulated value can be shifted. However, it is generally convenient to shift the stored accumulated value when implementing a circuit. Therefore, the shift may be viewed as shifting the stored accumulated value. The first accumulation operator 170 may be implemented as the dynamic logic circuit that operates according to the sub-clock signals. The dynamic logic circuit may be in the form of a register and may include, for example, at least one of a dynamic flip-flop or a true single phase clock (TSPC), but is not limited thereto.

To elaborate, the shift operation may be performed a total of (N-1) times from Bit1 to BitN. For example, when the output (OUT1) for Bit 1 arrives and the output (OUT2) for Bit2 arrives in in the next cycle, the shifted value of OUT1 and OUT2 are added. At this time, the shifting bit is 1-bit. When this operation is repeated up to Bit1N, a total of N-1 shifting occurs, and the total amount of shifting is equal to the number of CK_bits created in the sub-clock signal.

The first accumulation operator 170 may implement a multi-bit matrix product operation through shifting and adding performed based on outputs of the MAC logic circuit 150 that performs vector multiplication accumulation of 1 bit by 1 bit. For example, the first accumulator operator 170 may a first output of the MAC logic circuit 150 and store it, and may receive a second output, perform a bit shift thereon, and add it to the previously accumulated output. The bit shifting may depend on whether the memory cell unit 110 is big-endian or little-endian.

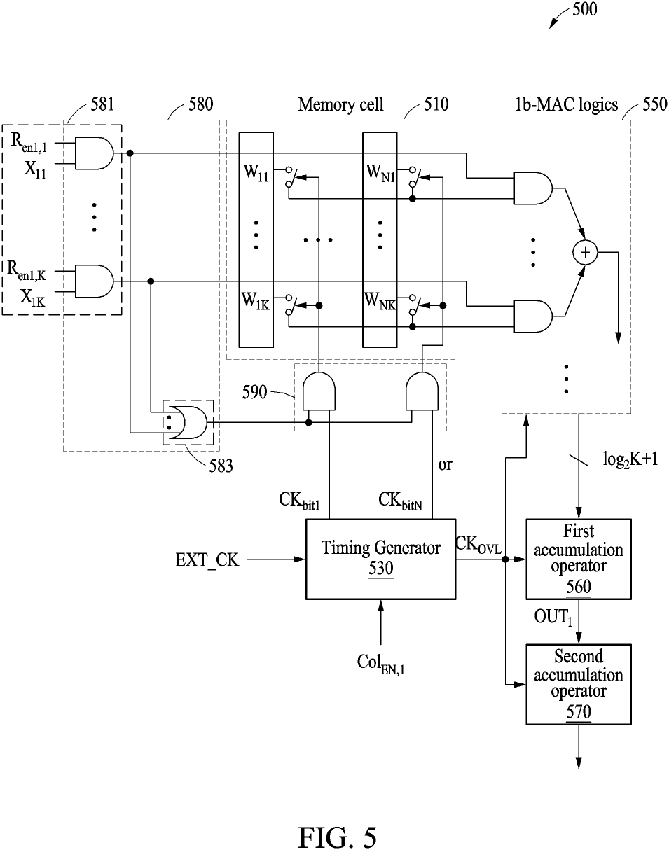

According to some embodiments, the IMC unit 100 may further include a row enabling block for generating row enabling signals for enabling the weight bits in units of rows. The structure and the operation of the IMC unit further including the row enabling block are described with reference to FIG. 5 below.

FIG. 2 illustrates an external timing diagram of an IMC unit, according to one or more embodiments. FIG. 2 illustrates an external clock signal EXT_CK 210, IN 230, and an asynchronous clock signal CK_{EN} 250 generated by a timing generator (e.g., the timing generator 130 of FIG. 1) based on the external clock signal EXT_CK 210 according to some embodiments.

The external clock signal EXT_CK 210 may correspond to a frequency of a system clock. The external clock signal EXT_CK 210 may branch four times at a maximum of 700 MH, for example.

The signal IN 230 may correspond to a 1-cycle enabling signal of the clock.

In one example embodiment, a plurality of clock signals CK_{EN} 250 may be generated during one external clock cycle (e.g., a cycle of the external clock signal EXT_CK 210) so that the logic of the IMC unit may perform an operation a plurality of times during an external clock cycle. The clock signals CK_{EN} may have a higher speed than the external clock signal EXT_CK 210. Since the IMC unit generates the clock signal CK_{EN} 250 by its own timing generator, conveniently, there may be no need to generate a separate high-speed clock signal outside of an IMC macro.

The clock signal CK_{EN} 250 may be generated by, for example, an oscillator that divides the external clock signal EXT_CK 210, but other techniques may be used, for example, a synchronization mechanism may allow separate clocks to generate the respective signals.

For an external clock cycle, the clock signal CK_{EN} 250 may be generated (pulsed), for example, 1.5 times the number N of bit cell arrays (the number of columns, or, the number of bits per word/weight) of a memory cell unit. In other words, in a case where the number of bit cell arrays N of the memory cell unit is four, the clock signals CK_{EN} 250 may be pulsed 4 × 1.5 = 6 times while the external clock signal EXT_CK 210 remains in an ON state. In this case, the number of clock signals CK_{EN} 250 may be changed in accordance with the number of pipeline stages (e.g., the number of columns or more, thus allowing a MAC operation to complete in a single external clock cycle). In some embodiments, the pipelining may apply to operations of multiple columns occurring at one time, e.g., AND-ing bits of one weight column with respective input bits while previous AND-ing results of a previous column are added, and while results prior thereto are accumulated.

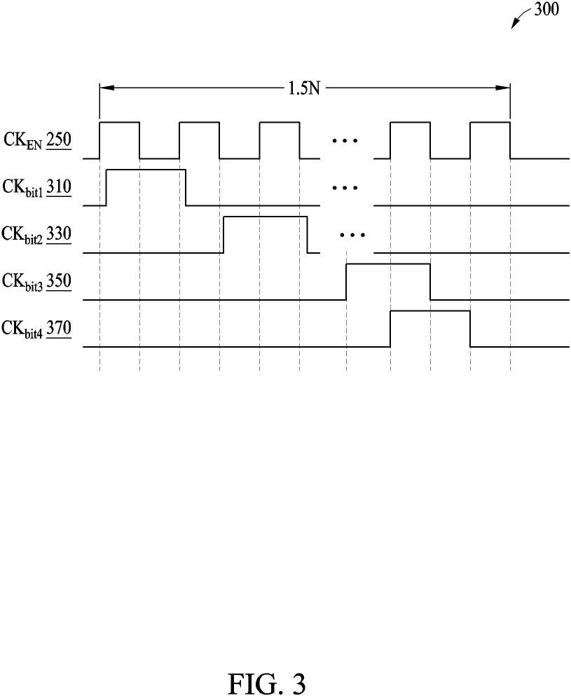

FIG. 3 illustrates an internal timing diagram of the IMC unit, according to one or more embodiments. FIG. 3 illustrates sub-clock signals for a (K=3)×(N=4) example; CK_{bit1} 310, CK_{bit2} 330, CK_{bit3} 350, and CK_{bit4} 370 are generated based on the clock signal CK_{EN} 250 with a high speed by the timing generator according to some embodiments.

The timing generator may sequentially generate the sub-clock signals CK_{bit1} 310, CK_{bit2} 330, CK_{bit3} 350, and CK_{bit4} 370, which are pulses for selecting the bit cell arrays (columns) of the memory cell unit, in other words, the weight bits in the units of columns, based on the clock signal CK_{EN} 250 with a high speed. The sub-clock signals CK_{bit1} 310, CK_{bit2} 330, CK_{bit3} 350, and CK_{bit4} 370 may have phases different from each other, as shown in the example of FIG. 3.

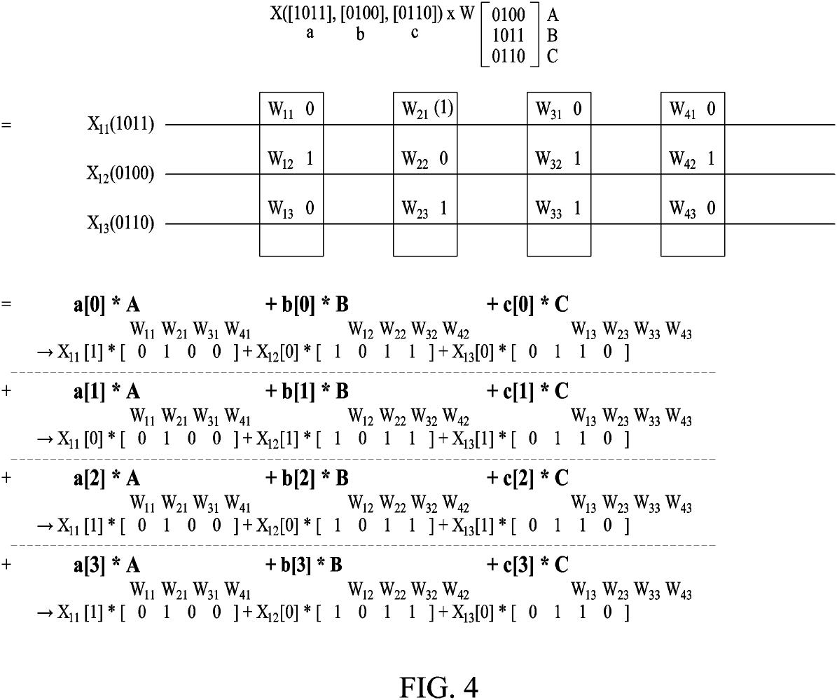

FIG. 4 illustrates a process 400 in which a matrix product operation is performed according to sub-clock signals in the IMC unit, according to one or more embodiments. FIG. 4 illustrates a process in which a 1-bit matrix product operation is performed between, for example, the input vector X including three elements, such as X₁₁ [1011], X₁₂ [0100], and X₁₃ [0110], and elements of weight vector W ([0,1,0,0], [1,0,1,1], and [0,1,1,0]) by the IMC unit, according to some embodiments.

According to the BPBS scheme, the IMC unit may sequentially perform MAC operations. The IMC unit may start with a MAC operation between first-inputted input bits (a[0], b[0], c[0]) and 4-bit weight elements (A, B, C), i.e., by the 1-bit (first bit) for each element of the input vector X. The IMC unit may perform 1-bit shifting-and-adding of MAC operation results between second-inputted input bits (a[1], b[1], c[1]) and the 4-bit weights (A, B, C) by the first accumulation operator, thereby calculating the MAC operation results between the 2-bit (second bit) input bits and the 4-bit weights, with accumulation of the previous operation. In addition, the IMC unit may sequentially perform a MAC operation between third-inputted input bits (a[2], b[2], c[2]) and the 4-bit weights (A, B, C), perform 1-bit shifting-and-adding by the first accumulation operator (with accumulation of the previous operations). Continuing the sequential iteration over the row-bits of the input vector X, a MAC operation between fourth-inputted bits (a[3], b[3], c[3]) and the 4-bit weights (A, B, C), and perform the 1-bit shifting-and-the adding by the first accumulation operator (with accumulation of the previous results), thereby obtaining MAC operation results between the 4-bit elements of the input vector and the respective 4-bit elements of the weight vector. In a case of the BPBS scheme, the MAC operations of various multi-bit dimensions may be output, which may facilitate precision, but variable, MAC configuration for MAC operations. Note that 1-bit shifting-and-adding refers to shifting by bits; some of the MAC operations, in correspondence with the place/order of the input bits, will involve more than one bit-shift.

FIG. 5 illustrates a structure of an IMC unit, according to one or more embodiments. FIG. 5 illustrates a structure of an IMC unit 500 based on an asynchronous digital single-bit BPBS according to some embodiments.

The IMC unit 500 may include a memory cell unit 510, a timing generator 530, a MAC logic circuit 550, a first accumulation operator 560, a second accumulation operator 570, and a row enabling block 580.

The structure and operation the memory cell unit 510, the timing generator 530, the MAC logic circuit 550, and the first accumulation operator 560 illustrated in FIG. 5 may be respectively the same as (or similar to) those of the memory cell unit 110, the timing generator 130, the MAC logic circuit 150, and the first accumulation operator 170 of the IMC unit 100 illustrated in FIG. 1, and therefore, configuration beyond that of FIG. 1 is mainly described hereinafter.

The second accumulation operator 570 may output a multi-bit matrix product operation result (corresponding to the input vector) by shifting multi-bit matrix product operation results of the first accumulation operator 560 by 1 bit according to the sub-clock signals generated by the timing generator 530 and cumulatively adding the multi-bit matrix product operation results.

The row enabling block 580 may provide or generate row enabling signals R_{en1,1}, R_{en1,2}, .., R_{en1,K} for enabling, in units of rows, the bit cells storing respective weight bits in the memory cell unit 510. The “enabling” may include both activation and enabling.

The row enabling signals may range from a first enabling signal R_{en1,1} that enables a first row unit (with the weight bits W₁₁, W₂₁, .., W_{N1}) of the memory cell unit 510, through the K-th row enabling signal R_{en1,K} that enables a K-th row unit (weight bits W_{1K}, W_{2K}, .., W_{NK}) of the memory cell unit 510. The phrase “row unit” refers to bit cells corresponding to one word line in the row direction in the memory cell unit 510. Moreover, as an example, in a case where a weight element has 4 bits, N is 4, and in a case where the weight element has 8 bits, N is 8. The row enabling block 580 may include a number of AND gates 581 (e.g., K AND gates) respectively corresponding to the number of elements of the input vector, and one OR gate 583 configured to perform an OR operation on outputs of the plurality of AND gates 581 (there may be additional AND and OR gates that may be unused for some values of N). In some embodiments, the OR gates 583 may be implemented as NOR gates.

To enable any one data path in the row direction that is used in the memory cell unit 510, the IMC unit 500 may perform AND operations with the AND gates 581 on respective pairings of (1) the input bits included in the input vector that is being inputted to the row enabling block 580 and (2) the row enabling signals R_{en1,1} to R_{en1,K}. In other words, the row enabling block 580 may enable the weight bits in units of rows by performing the AND operation between each of the input bits and the respectively corresponding row enabling signals by using the plurality of AND gates 581. In some embodiments, the AND gates 581 may be configured as NAND gates.

The IMC unit 500 may further have an enabling function for the input bits input in the row direction by using the AND gates 581. When the enabling function for the input bits input in the row direction is used as described above, although a small matrix product is performed, a toggle that a state for a part not being used is changed does not occur. Accordingly, electrical efficiency is not reduced due to the characteristics of a digital circuit and a plurality of small matrix products may be stored inside one IMC unit 500, which may be advantageous in system implementation.

In a case where all of the row enabling signals Rₑₙ are in an OFF state, the IMC unit 500 may prevent power use when weight bits stored in the memory cell unit 510 are not used through the OR gate 583 of the row enabling block 580. According to some embodiments, the OR gate 583 may be configured as a NOR gate that performs a NOR operation.

The IMC unit 500 may include AND gates 590 that perform an AND operation between an output signal of the OR gate 583 and each of sub-clock signals output from the timing generator 530 so that a load due to the weight bits of the memory cell unit 510 is cut off, in a case where the input bits are not input. In this case, the number of AND gates 590 may correspond to the number of (e.g., N) dimensions of the weight vector.

In a case where the row enabling signals R_{en1,1}, R_{en1,2}, ..., and R_{en1,K} respectively corresponding to all rows are “0” (or are in an OFF state) and/or in a case where the input bits are not input, the row enabling block 580 may perform an OR operation for cutting off load due to the weight bits by the OR gate 583, thereby preventing the power loss/use when the memory cell unit 510 is not used. In other words, in a case where an output of “1” does not occur from the plurality of AND gates 581 of the row enabling block 580, the IMC unit 500 may, through the OR gate 583, transmit “0” as inputs to the AND gates 590 that connect the memory cell unit 510 and the timing generator 530, thereby preventing the power loss/use due to the memory cell unit 510.

The timing generator 530 may generate the clock signals CK_{OVL} (CK_{OVL} representing any of the overlapping signals) that may mutually overlap to perform the MAC operation between input bits and voltages respectively loaded from the sub-clock signals.

The weight bits stored in the memory cell unit 510 may be sequentially loaded to the MAC logic circuit 550 according to the sub-clock signals CK_{bit}. The MAC logic circuit 550 may be designed as a dynamic logic circuit, such as, for example, a clock-logic domino circuit, and may be pipelined according to the overlapping clock signals CK_{OVL} for operation. This process may be applied to the first accumulation operator 560 in the same manner.

The MAC logic circuit 550 may be designed in a pipeline structure by a dynamic logic circuit and an overlapping clock. The IMC unit 500 may implement the pipeline structure, for example, by generating the overlapping clock signals CK_{OVL} by using the clock signal CK_{EN} 250, configuring the 1 bit-MAC logic circuit 550 as the dynamic logic circuit, and operating the 1 bit-MAC logic circuit 550.

According to some embodiments, a high-speed operation of the MAC logic circuit 550 may be performed by the pipeline structure and the difficulty of increasing the number of input bits input in the row direction is reduced, and accordingly, the IMC unit 500 may also be utilized in a relatively large matrix product operation.

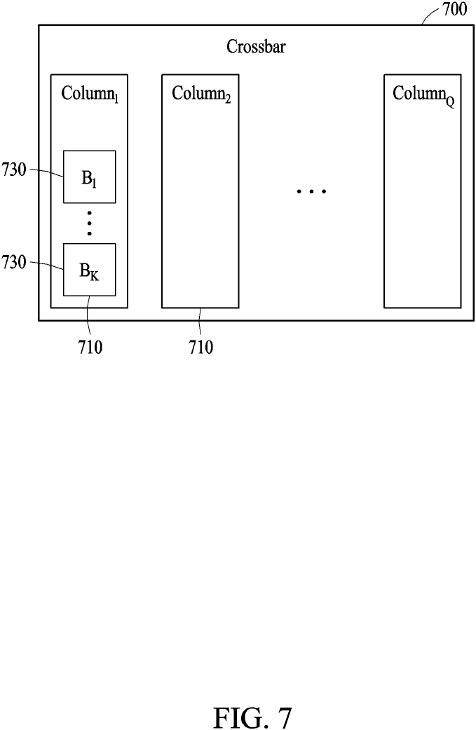

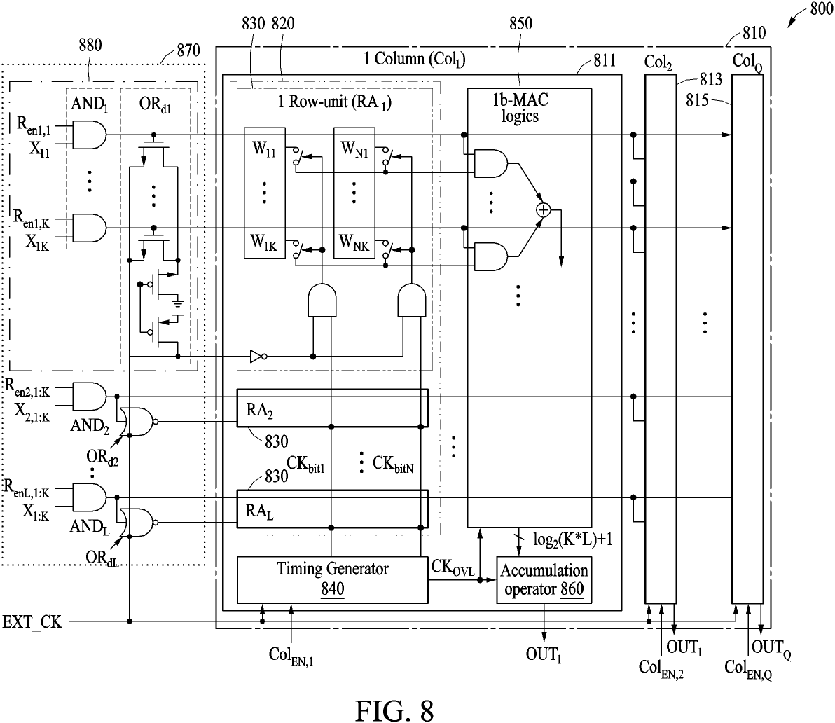

In a case where the IMC unit 500 is, for example, included in an IMC macro configured with a plurality of columns in a crossbar structure illustrated in FIGS. 7 and 8 below, the control signal Col_{EN} applied to the timing generator 530 may correspond to a column control signal that may not operate a corresponding column. For example, when “0” is input as the column control signal Col_{EN,1} (or, there is no signal), the IMC unit 500 of the corresponding column may not operate.

Compared to a case where the MAC logic circuit 550 uses a multi-bit adder tree for the matrix product operation, by using a shared adder, the IMC unit 500 may have a significantly lower number of adders used and an area occupied by the MAC logic circuit 550 in the IMC unit 500 may be reduced, and the operation speed of the MAC logic circuit 550 may be relatively higher.

The IMC unit 500 may also have a reduced number of transistors required for the matrix product operation by configuring the MAC logic circuit 550 and/or the first and second accumulation operators 560 and 570 with the dynamic logic circuit. In addition, the IMC unit 500 may enable a high-speed operation like a pipeline, by operating the dynamic logic circuit (e.g., the MAC logic circuit 550 and/or the first and second accumulation operators 560 and 570) through the overlapping clock signals CK_{OVL} based on asynchronous sub-clock signals, which are not synchronized with the external clock signal EXT_CK.

The number of weight columns (e.g., W₁₁ to W_{1K}) of the memory cell that shares (that is connected by a switch to) the 1bit-MAC logic circuit in the row direction in the IMC unit 500 may also be freely increased by such a high-speed operation. When the storage capacity of the memory per unit area as a whole is to be increased, the number of memory rows in the IMC unit 500 may be increased by connecting such memory rows to the 1b-MAC logic circuit through a switch.

Various embodiments of the IMC unit 500 as described above may perform a digital operation for the matrix product operation in a small area and, at the same time, enable a high-speed operation through asynchronous clock signals and the dynamic logic circuit, and therefore, the IMC unit 500 may be utilized in various fields, such as in-memory computing-related fields, a neural processing unit (NPU), an artificial intelligence (AI) accelerator, and/or a memory macro capable of performing operations, in addition to the application fields where static random access memory (SRAM) is used.

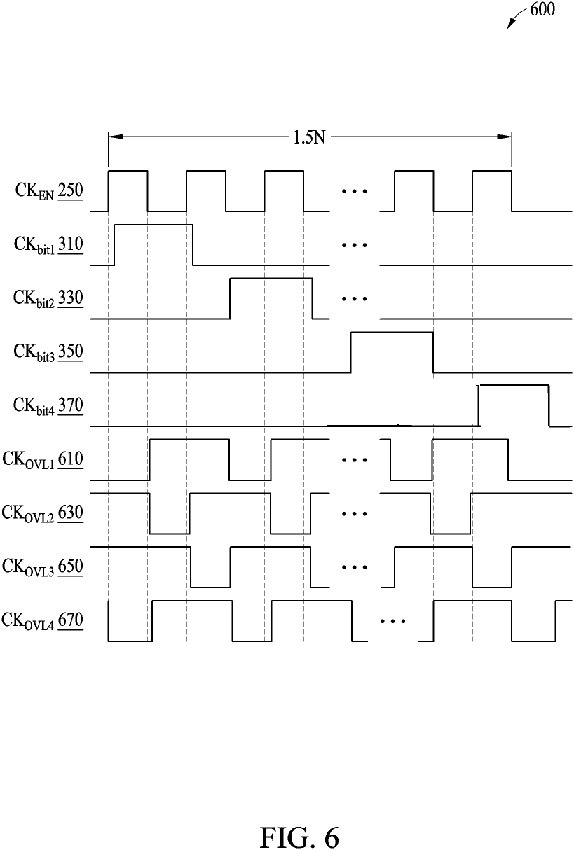

FIG. 6 illustrates clock signals generated by a timing generator, according to one or more embodiments. FIG. 6 illustrates the asynchronous sub-clock signals 310, 330, 350, and 370 based on the clock signal CK_{EN} 250 and overlapping clock signals 610, 630, 650, and 670 generated by overlapping the sub-clock signals 310, 330, 350, and 370 according to an some embodiments.

The clock signal CK_{EN} 250 may be generated, for example, in a number corresponding to 1.5 times the number N of bit cell arrays (columns) of the memory cell unit 110.

The sub-clock signals 310, 330, 350, and 370 and/or the overlapping clock signals 610, 630, 650, and 670 may be generated, for example, by (or based on) the number of elements of the input vector and the number K of word lines of the memory cell unit.

The overlapping clock signals 610, 630, 650, and 670 may be generated by, for example, a shift register or an inverter delay element. A method of generating the overlapping clock signals 610, 630, 650, and 670 is well known, and therefore, a detailed description thereof is omitted. In some embodiments, an overlap signal may overlap at least with (and in some examples only with) adjacent overclock signals (with the 1-th and N-th signals being adjacent).

The overlapping clock signals 610, 630, 650, and 670 have an effect of pulling a rising edge of each clock signal, but in a case of being used as they are in the memory cell unit 110, clock signals, which are switched on at the same time, may be generated. The overlapping clock signals 610, 630, 650, and 670 may be used, for example, by inverting the sub-clock signals 310, 330, 350, and 370.

FIG. 7 illustrates a schematic form of a crossbar structure of the IMC unit, according to one or more embodiments. FIG. 7 illustrates a crossbar structure 700 configured with a plurality of columns 710 according to some embodiments.

Each of the plurality of columns 710 may include, for example, a memory cell array including K (a natural number satisfying K > 0) memory cell units B₁ to B_{K} 730. The MAC operation may be performed by the K memory cell units B₁ to B_{K} 730 included in each column. It will be appreciated that the crossbar structure 700 may function as addressable memory regardless of the use of the in-memory computing techniques described herein.

For example, a multiplication operation may be performed in a bit cell unit (row unit) of memory cell units included in each of the columns 710 together with an input, and an accumulation operation may be performed in a column unit of weight vectors of the memory cell units included in each of the columns 710.

FIG. 8 illustrates a structure of an IMC macro, according to one or more embodiments. FIG. 8 illustrates a structure of an IMC macro 800 including an IMC array 810 configured with columns in a crossbar structure and an enabling circuit 870 according to some embodiments.

The IMC array 810 generates sub-clock signals CK_{bit} based on the external clock signal EXT_CK for each of the columns Col₁, Col₂, ..., and Col_{Q} in a crossbar structure. Details of column 1 (Col₁) are representative of details of the other columns.

The IMC array 810 respectively includes, in the plurality of columns Col₁, Col₂, ..., and Col_{Q} in a crossbar structure, IMC units 811, 813, and 815 that perform matrix product operations between weight bits in the column unit of the weight vector W and the input bits of the input vector X, the weight bits being sequentially loaded or read from the memory cell array 820 (which includes memory cell units RA₁, RA₂, ..., RA_{L} 830) according to the sub-clock signals. The memory cell array 820 may be referred to as a “memory row array”.

The memory cell units RA₁, RA₂, ..., and RA_{L} 830 may share sub-clock signals. Each of the plurality of memory cell units RA₁, RA₂, ..., and RA_{L} 830 may be referred to as a “row unit”. In other words, the memory cell units of a given column (IMC unit) may share the same sub-clock signals generated by the given column’s (IMC unit’s) timing generator (overlapping and/or otherwise).

Each of the IMC units 811, 813, and 815 may include, for example, its own respective memory cell array 820, timing generator 840, MAC logic array 850, and accumulation operator 860.

In the memory cell array 820, the memory cell units 830 may be arranged in units of rows.

The timing generator 840 may, as described above, generate sub-clock signals for selecting weight bits in units of columns (i.e., a whole column is selected by a corresponding sub-clock signal) included in each of the plurality of memory cell units 830, based on the external clock signal EXT_CK. Alternatively, the timing generator 840 may generate overlapping clock signals obtained by overlapping sub-clock signals having different phases for each of the columns that they respectively correspond to, i.e., each column unit’s sub-clock signal may have a phase that is different than, and partially overlapping (both are “ON”) at least one other column’s sub-clock signal, where the other column may be an adjacent column.

The timing generators 840 of the respective columns may be driven according to respective column control signals Col_{EN,1}, Col_{EN,2}, ..., Col_{EN,Q} which control generation of he sub-clock signals for each of the respective columns.

The MAC logic array 850 may perform, through pipelining, a matrix product operation between input bits and weight bits sequentially loaded to each of the plurality of memory cell units 830, according to the sub-clock signals generated by the timing generator 840. The MAC logic array 850 may output, for example, (log₂ (K*L) + 1) bits to the accumulation operator 860 as a matrix product operation result, where K is the number of elements included in the input vector X and the number of word lines included in one memory cell unit 830, and where L is the number of memory cell units 830 included in the memory cell array 820.

The MAC logic array 850 may correspond to a structure in which a MAC logic circuit corresponding to each of the cell units 830 expands in the row direction, considering that the MAC logic circuit readily expands in the row direction, since the MAC logic circuit (e.g., MAC logic circuit 550 of FIG. 5) is able to perform a high-speed operation through pipelining in the row direction.

The MAC logic array 850 may be pipelined by the overlapping clock signals CK_{OVL} generated by the timing generator 840 to perform a single-bit matrix product operation corresponding to each of the IMC units 811, 813, and 815.

The MAC logic array 850 may include MAC logic circuits 855 respectively corresponding to the memory cell units 830. Each of the MAC logic circuits 855 may include AND gates respectively corresponding to the number of elements of the input vector, and one shared adder that performs an addition operation on outputs of the plurality of AND gates.

The accumulation operator 860 may output a multi-bit matrix product operation result corresponding to the input bits by shifting and adding the operation result of the MAC logic array 850 according to the sub-clock signals. In addition, the accumulation operator 860 may output multi-bit matrix product operation results corresponding to the input vector by shifting the multi-bit matrix product operation result by one bit according to the sub-clock signals and adding the multi-bit matrix product operation results. The accumulation operator 860 may include, for example, the first accumulation operator 560 and the second accumulation operator 570 described above with reference to FIG. 5, but is not limited thereto.

The MAC logic array 850 and/or the accumulation operator 860 may be configured as a dynamic logic circuit (a type of integrated circuit design), for example.

The enabling circuit 870 may include a row enabling block 880 corresponding to each of the memory cell units 830. The enabling circuit 870 may generate enabling signals R_{en1,1} to Ren_{L,1:K} for enabling weight bits included in each of the columns for each of the cell units 830 by the row enabling block 880.

The row enabling block 880 may include AND gates AND₁, ..., through AND_{L} respectively corresponding to the number of elements of the input vector and one OR gate OR_{d1} that performs an OR operation on outputs of the plurality of AND gates AND₁, ..., through AND_{L}. In this case, OR gates OR_{d1}, OR_{d2}, ..., and OR_{dL} respectively included in the row enabling blocks 880 included in the enabling circuit 870 are implemented as a dynamic logic circuit such as domino logic circuit so as to configure the corresponding circuit, and thus, the number of transistors used may be reduced, as well as an area occupied by the enabling circuit 870 in the IMC macro 800.

The number of memory cell arrays 820 and the number of memory cell units 830 included in the IMC macro 800 may be adjusted according to conditions, such as an area and/or throughput of the IMC macro 800.

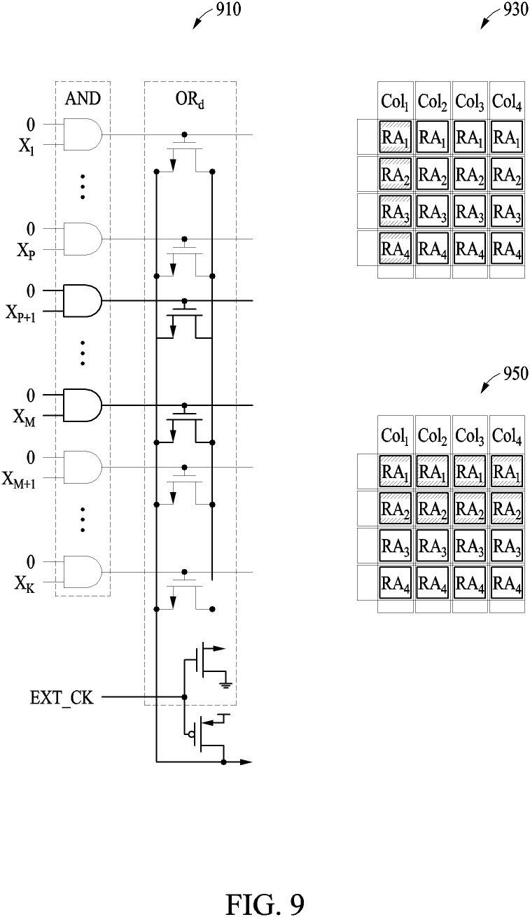

FIG. 9 illustrates a method of implementing various types of vector products by using one MAC logic in the IMC macro, according to one or more embodiments.

In FIG. 9, part 910 shows a case where bit cells are selected in units of rows in a memory cell unit by a row enabling block (e.g., the row enabling block 820 of FIG. 8) in any one IMC unit (e.g., the IMC unit 811 of FIG. 8) included in the IMC macro. Parts 930 and 950 show cases where bit cells are selected in units of rows and columns in the IMC macro, where the IMC macro includes a memory cell arrays including memory cell units RA₁, RA₂, RA₃, and RA₄ for each of respective columns Col₁, Col₂, Col₃, and Col₄ of the IMC macro, according to some embodiments.

According to some embodiments, the number of memory cell units in the row direction to be selected may be easily changed, not only in one memory cell array, but also in a plurality of memory cell arrays. The IMC unit may perform the MAC operation, for example, by selecting a particular memory cell in the row direction from one memory cell array as illustrated in the part 910, by a row enabling signal Rₑₙ. In this case, the row enabling block may set a row enabling signal Rₑₙ corresponding to a bit cell not selected in the memory cell unit to “0” or “off”. In the memory cell array, the bit cells corresponding to the enabling signal “0” are switched off, and accordingly, the input bit may not be transmitted to the MAC logic circuit.

Alternatively, the row enabling block may set the row enabling signal Rₑₙ corresponding to the bit cell selected in the memory cell unit to “1” or ON. In the memory cell array, the bit cells corresponding to the enabling signal “1” are switched on, and accordingly, the input bit is transmitted to the MAC logic circuit, thereby performing the MAC operation corresponding to the selected bit cell(s) in units of rows.

The process described above may be similarly applied to the IMC macro including a plurality of memory cell arrays for each column.

For example, as illustrated in the parts 930 and 950, in the IMC macro using a plurality of memory cell arrays for each column, the selection of columns may be controlled through column control signals (e.g., Col_{EN,1}, Col_{EN,2}, ..., and Col_{EN,Q}) corresponding to the respective columns, and therefore the matrix product operation may be performed for various sizes of matrices.

Between the column control signals and the row enabling signals, the IMC macro may enable and use, for example, any one column (e.g., the first column Col₁) and any four rows, in other words, four memory cell units RA₁, RA₂, RA₃, and RA₄ included in the corresponding enabled column (e.g., the first column Col₁), as shown with the hatched (shaded) portions in the part 930 by the row enabling signal and the column control signal. In other words, memory cell unit may be enabled if its corresponding column control signal and its corresponding row enabling signal are both ON.

Alternatively, the IMC macro may enable and use four columns (e.g., the first column Col₁ to the fourth column Col₄) and two rows (e.g., RA₁ and RA₂) included in the corresponding columns (e.g., the first column Col₁ to the fourth column Col₄), which are hatched in the part 950, by setting ON the corresponding row enabling signals and the column control signals.

In one example embodiment, since the particular memory cell unit(s) are selected and used in units of rows and/or in units of columns by the row enabling signal and/or the column control signal, the storage space in the IMC unit and/or the IMC macro may have high utilization, and also, various types of vector products may be implemented by the MAC logic circuit or one MAC logic array.

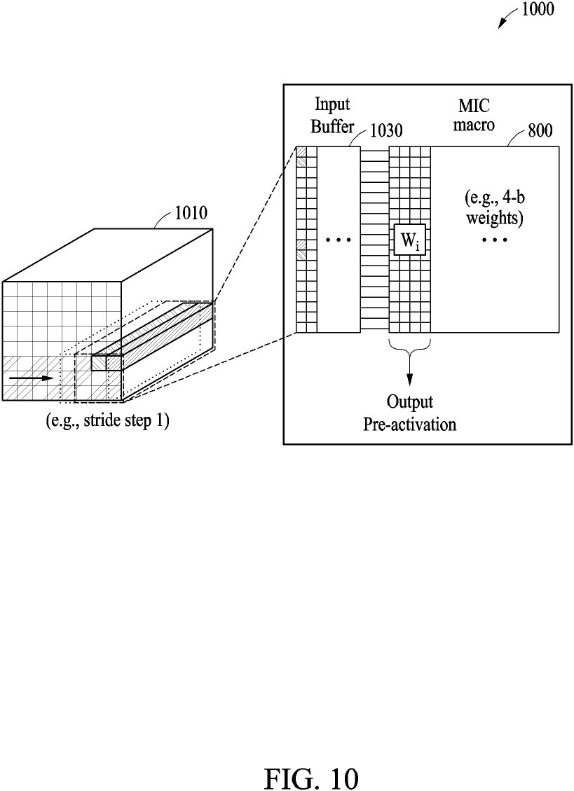

FIG. 10 illustrates an example in which the IMC macro is used for a matrix product operation of a convolutional neural network (CNN), according to one or more embodiments. FIG. 10 illustrates an example 1000 of a situation where an input vector 1010 input to a CNN is stored in an input buffer 1030, and a weight vector Wᵢ corresponding to a kernel of the CNN is stored in an IMC macro 800 according to some embodiments.

The CNN kernel may extract features by applying weights thereof to each input vector elements. The kernel may correspond to, for example, a matrix having a size of n × m. The CNN may output a value obtained based on multiplying and adding all values of elements of the kernel and each overlapping portion of an image (or input vector) having a size of n × m, while overlapping and scanning an image having a size of a height × width from beginning to end by the kernel (i.e., convolving the kernel over the image or input vector).

For example, a kernel, which is a matrix having a size of 3 × 4, may be flattened to a size of 1 × 4 and stored in the IMC macro 800 for each column.

The input vector 1010 (or portions thereof) may also be stored in the input buffer 1030 for each column and then input to the IMC macro 800. In this case, portions of the input vector 1010 corresponding to several strides are sequentially stored in the input buffer 1030 for each column, and accordingly, the operations of several strides may be performed in one IMC macro 800 at the same time.

In some embodiments, the IMC macro 800 may improve energy efficiency and/or a signal-to-noise ratio (SNR) by deactivating, using the row enabling signals Rₑₙ and/or the column control signals Col_{EN}, rows and/or columns that are not often used in the weight vector Wᵢ corresponding to the kernel.

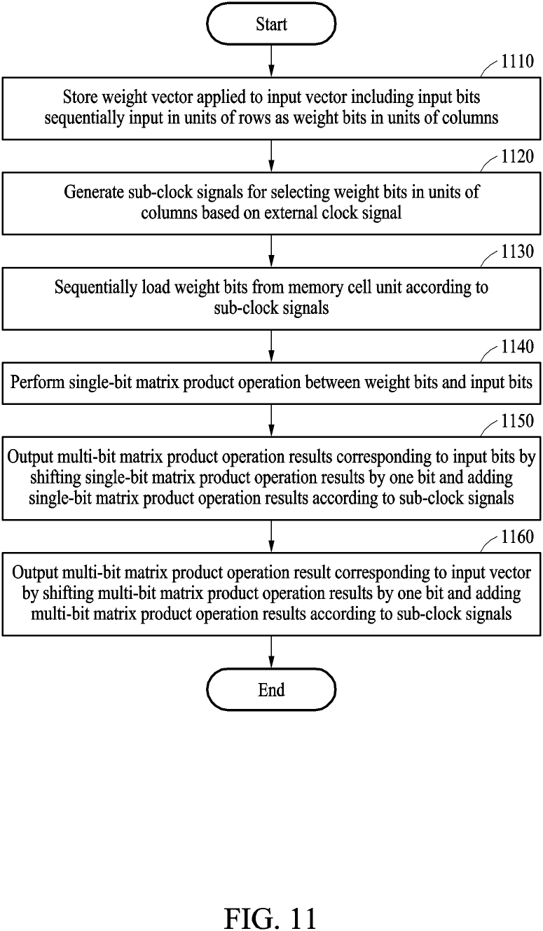

FIG. 11 illustrates an operating method of the IMC unit, according to one or more embodiments. In the following example embodiments, operations may be performed sequentially, but are not necessarily limited thereto. For example, the order of the operations may be changed and some operations may be performed in parallel.

Referring to FIG. 11, the IMC unit according to some embodiments may perform a multi-bit matrix product operation through operations 1110 to 1160.

In operation 1110, the IMC unit stores a weight vector that is to be applied to an input vector. The weight vector includes columns of weight bits. The input vector includes rows of input bits. The rows are sequentially input to the IMC unit, as units of rows and applied, as units of rows, to the columns as units of columns. The IMC unit may store the weight bits in units of columns in each of the bit cells of a memory cell unit. The memory cell unit may be, for example, the memory cell unit 110 of FIG. 1 and/or the memory cell unit 510 of FIG. 5, but is not limited thereto.

In operation 1120, the IMC unit generates sub-clock signals for selecting, as units of columns, the weight bits stored in operation 1110; the sub-clock signals may be generated based on the external clock signal. The IMC unit may generate the sub-clock by using a timing generator, based on the external clock signal. The timing generator may be, for example, the timing generator 130 of FIG. 1, and/or the timing generator 530 of FIG. 5, but is not limited thereto.

In operation 1130, the IMC unit sequentially reads the weight bits from the memory cell unit according to the sub-clock signals.

In operation 1140, the IMC unit performs a single-bit matrix product operation between the input bits and the weight bits sequentially loaded in operation 1130. The IMC unit may perform a single-bit matrix product operation by, for example, a MAC logic circuit. The MAC logic circuit may be, for example, the MAC logic circuit 150 of FIG. 1 and/or the MAC logic circuit 550 of FIG. 5, but is not limited thereto.

In operation 1150, the IMC unit shifts the single-bit matrix product operation results (from operation 1140) by one bit and adds the shifted results to output multi-bit matrix product operation results corresponding to the input bits according to the sub-clock signals. The IMC unit may shift the single-bit matrix product operation results by one bit and may add the single-bit matrix product operation results by the first accumulation operator 170 of FIG. 1 and/or the first accumulation operator 560 of FIG. 5, but is not limited thereto.

In operation 1160, the IMC unit shifts the multi-bit matrix product operation results of operation 1150 by one bit and adds the multi-bit matrix product operation results to output multi-bit matrix product operation results corresponding to the input vector according to the sub-clock signals. The IMC unit may, for example, shift the multi-bit matrix product operation results by one bit and add the multi-bit matrix product operation results by the second accumulation operator 570 of FIG. 5, but is not limited thereto.

The computing apparatuses, electronic devices, processors, memories, displays, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An in-memory computing (IMC) unit comprising:
a memory cell configured to store a weight vector as columns of weight bits, the memory cell unit further configured to apply an input vector to the weight vector, the input vector comprising rows of input bits, wherein the IMC unit is configured to apply the rows sequentially, as units of rows, to the columns;
a timing generator configured to, based on an external clock signal, generate sub-clock signals for selecting the columns as units of columns;
a multiplying and accumulator (MAC) logic circuit configured to perform a single-bit matrix product operation between the weight bits and the input bits, the weight bits being sequentially loaded to the MAC logic circuit from the memory cell unit according to the sub-clock signals; and
a first accumulation operator configured to output multi-bit matrix product operation results respectively corresponding to the input bits by shifting and adding operation results of the MAC logic circuit according to the sub-clock signals.

2. The IMC unit of claim 1, wherein the timing generator is configured to sequentially generate the sub-clock signals, at least some of which have different phases with respect to each other, for selecting the columns, based on an external clock signal that is generated outside of the IMC unit.

3. The IMC unit of claim 2, wherein the timing generator is configured to generate the sub-clock signals such that at least some of the sub-clock signals have different phases with respect to each other or such that at least some pairs of the sub-clock signals are in an ON state at the same time.

4. The IMC unit of claim 3, wherein
the MAC logic circuit is implemented by a dynamic logic circuit comprising a domino logic and/or by a static logic circuit, and wherein
the dynamic logic circuit is configured to operate as a pipeline in accordance with the sub-clock signals to perform the single-bit matrix product operation.

5. The IMC unit of claim 1, wherein the MAC logic circuit comprises:
AND gates respectively corresponding to elements of the input vector, wherein the number of AND gates is greater than or equal to the number of elements; and
one shared adder configured to perform an addition operation on outputs of the AND gates.

6. The IMC unit of claim 5, wherein the MAC logic circuit is configured to perform the single-bit matrix product operation by performing multiplication operations between each of the weight bits and each of the input bits by using the AND gates and performing an addition operation on results of the multiplication operations by using the one shared adder.

7. The IMC unit of claim 1, wherein
the first accumulation operator is implemented as a dynamic logic circuit configured to operate according to the sub-clock signals, and
the dynamic logic circuit has a register form and comprises at least one of a dynamic flip-flop or a true single phase clock (TSPC).

8. The IMC unit of claim 1, further comprising:
a second accumulation operator configured to shift the multi-bit matrix product operation results by one bit and add the multi-bit matrix product operation results according to the sub-clock signals to output a multi-bit matrix product operation result corresponding to the input vector.

9. The IMC unit of claim 1, further comprising a row enabling block configured to generate row enabling signals for enabling the weight bits by respective units of rows.

10. The IMC unit of claim 9, wherein the row enabling block comprises:
AND gates respectively corresponding to elements of the input vector; and
one OR gate configured to perform an OR operation on outputs of the respective AND gates.

11. The IMC unit of claim 10, wherein the row enabling block is configured to enable the weight bits by units of rows by performing an AND operation between each of the input bits and the row enabling signals using the AND gates.

12. The IMC unit of claim 10, further comprising:
AND gates configured to perform an AND operation between an output signal of the OR gate and each of the sub-clock signals such that a load of weight bits is prevented within the IMC unit in a case where the corresponding input bits are not input to the memory cell,
wherein the number of AND gates corresponds to a number of dimensions of the weight vector.

13. An in-memory computing (IMC) macro comprising:
an IMC array comprising an IMC configured to share sub-clock signals that are generated based on an external clock signal and control respective columns having a crossbar structure, wherein the IMC is further configured to perform a matrix product operation between weight bits by units of columns thereof and input bits of an input vector, the weight bits being sequentially loaded, according to the sub-clock signals, from a memory cell array comprising memory cell units; and
an enabling circuit configured to generate enabling signals for enabling the weight bits included in each of the plurality of columns, for each of the plurality of memory cells.

14. The IMC macro of claim 13, wherein the IMC comprises:
the memory cell array, within which the memory cells are arranged in units of rows;
a timing generator configured to generate the sub-clock signals based on the external clock signal;
a multiplying and accumulator (MAC) logic array configured to perform a matrix product operation between the weight bits and the input bits through pipelining, the weight bits being sequentially loaded to each of the memory cells according to the sub-clock signals; and
a first accumulation operator configured to output multi-bit matrix product operation results corresponding to the input bits by shifting and adding operation results of the MAC logic array according to the sub-clock signals.

15. The IMC macro of claim 14, wherein
the timing generator is configured to generate overlapping clock signals obtained by overlapping sub-clock signals having different phases for each of the respective columns, and wherein
the MAC logic array is pipelined by the overlapping clock signals to perform a single-bit matrix product operation.

16. The IMC macro of claim 14, wherein the timing generator is driven according to a control signal for controlling generation of the sub-clock signals for each of the columns.

17. The IMC macro of claim 14, wherein
the MAC logic array comprises MAC logic circuits respectively corresponding to the memory cells, and
each of the MAC logic circuits comprises:
AND gates respectively corresponding to elements of the input vector; and
one shared adder configured to perform an addition operation on outputs of the AND gates.

18. The IMC macro of claim 13, wherein
the enabling circuit comprises a row enabling block corresponding to each of memory cells, and wherein
the row enabling block comprises:
AND gates respectively corresponding to elements of the input vector, and
one OR gate configured to perform an OR operation on outputs of the AND gates.

19. A method of operating a memory comprising a memory cell unit, the method comprising:
storing a weight vector as weight bits in units of columns, the weight vector being applied to an input vector comprising input bits sequentially input in units of rows;
generating sub-clock signals for selecting the weight bits in the units of columns, based on an external clock signal;
sequentially loading the weight bits, column by column, from the memory cell unit according to the sub-clock signals;
performing a single-bit matrix product operation between the weight bits and the input bits;
shifting results of the single-bit matrix product operation by one bit and adding the single-bit matrix product operation results according to the sub-clock signals to output multi-bit matrix product operation results respectively corresponding to the input bits; and
shifting the multi-bit matrix product operation results by one bit and adding the multi-bit matrix product operation results according to the sub-clock signals to output a multi-bit matrix product operation result corresponding to the input vector.

20. The method of claim 19, wherein the method comprises a multiply-and-accumulate (MAC) operation between the input vector and the weight vector, the MAC operation comprising the single-bit matrix product operation and the multi-bit matrix product operation.
